(19) United States
(12) Patent Application Publication
(10) Pub. No.: US 2026/0302680 A1
(43) Pub. Date: Oct. 1, 2026

(54) ELECTRICAL CONNECTOR WITH IMPROVED REINFORCING MEMBER

(71) Applicants: Fuyu Electronic Technology (Huai'an) Co., Ltd., Huaian (CN); FOXCONN INTERCONNECT TECHNOLOGY LIMITED, Grand Cayman (KY)

(72) Inventors: MING-YI GONG, Huaian (CN); XUN WU, Huaian (CN); XIAO-HU YIN, Huaian (CN)

(21) Appl. No.: 19/632,889

(22) Filed: Mar. 30, 2026

(30) Foreign Application Priority Data
Mar. 31, 2025 (CN) 202520589599.0

(51) Int. Cl. H01R 13/502; H01R 12/73; H01R 13/6581

(52) U.S. Cl. CPC H01R 13/502; H01R 12/737; H01R 13/6581

(57) ABSTRACT

An electrical connector includes: an insulating housing having two opposite side walls, a mating slot, and a fool-proof portion spanning the mating slot, the fool-proof portion dividing the mating slot into a first slot and a second slot; plural terminals disposed on the two side walls; and a reinforcing member; wherein the reinforcing member includes a bent body having a first body covering a top surface of the fool-proof portion, and a second body and a third body bent downward from opposite ends of the first body respectively, the second body and the third body cover opposite sides of the fool-proof portion respectively and face the second slot and the first slot respectively; and a first extension portion and a second extension portion are partly fixed to the corresponding side wall.

### BACKGROUND OF THE INVENTION

### 1. Field of the Invention

The present invention relates generally to an electrical connector, and particularly to an electrical connector with an improved reinforcing member.

### 2. Description of Related Arts

U.S. Pat. No. 8,215,994 discloses an electrical connector for a daughter board, including an insulating elongated housing extending along a longitudinal direction and a plurality of contacts each having a retention portion retained in the housing. The housing has opposite first side wall and second side wall and a central slot formed between the first and second side walls for receiving the daughter board. The housing includes a fool-proof portion connecting the two side walls to prevent reverse insertion of the daughter board. However, the fool-proof portion is relatively weak and may be damaged by impact from the daughter board during insertion or removal.

An improved electrical connector is desired.

### SUMMARY OF THE INVENTION

An object of the present invention is to provide an electrical connector for enhancing structural strength.

To achieve the above-mentioned object, an electrical connector comprises: an insulating housing having two opposite side walls extending in a first direction, a mating slot located between the two side walls and defining a mating direction, and a fool-proof portion spanning the mating slot, the fool-proof portion dividing the mating slot into a first slot and a second slot in the first direction; a plurality of terminals disposed on the two side walls respectively and located at two lateral sides of the mating slot; and a reinforcing member retained on the insulating housing, wherein the reinforcing member comprises: a bent body comprising a first body covering a top surface of the fool-proof portion, and a second body and a third body bent downward from opposite ends of the first body respectively, the second body and the third body covering opposite sides of the fool-proof portion respectively and facing the second slot and the first slot respectively; a first extension portion comprising a first extension body extending from the second body and two first bent portions bent from two lateral edges of the first extension body respectively, the first bent portions being fixed to corresponding side walls; and a second extension portion comprises a second extension body laterally from the third body and two second bent portions bent from two lateral edges of the second extension body respectively, the second bent portions being fixed to corresponding side walls.

Other advantages and novel features of the invention will become more apparent from the following detailed description of the present embodiment when taken in conjunction with the accompanying drawings.

### BRIEF DESCRIPTION OF DRAWINGS

FIG. 1 is a perspective view of an electrical connector of a first embodiment of the present invention;

FIG. 2 is an exploded perspective view of the electrical connector of FIG. 1;

FIG. 3 is a further exploded perspective view of the electrical connector of FIG. 2;

FIG. 4 is a perspective view showing the assembly of an insulating housing and a reinforcing member of the electrical connector of FIG. 1;

FIG. 5 is a sectional view of the electrical connector of FIG. 1;

FIG. 6 is a perspective view of the reinforcing member of the electrical connector of FIG. 1;

FIG. 7 is a perspective view of an electrical connector of a second embodiment of the present invention;

FIG. 8 is an exploded perspective view of the electrical connector of FIG. 7;

FIG. 9 is a sectional view of the electrical connector of FIG. 7; and

FIG. 10 is a sectional view of a metal shell of the electrical connector of FIG. 7.

### DETAILED DESCRIPTION OF THE PREFERRED EMBODIMENT

Reference will now be made to the drawing figures to describe the preferred embodiment of the present invention in detail.

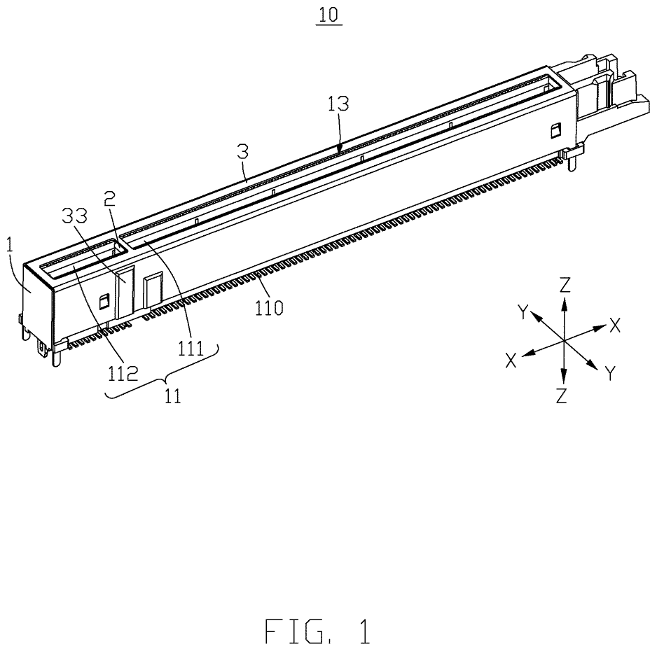

Referring to FIGS. 1-3, an electrical connector 10 of a first embodiment of the present application includes a longitudinal insulating housing 1, a plurality of terminals 110, and a reinforcing member 2 retained on the insulating housing. The insulating housing 1 has two opposite side walls 101 extending in a first direction X-X, a mating slot 11 penetrating upward between the two side walls 101 and defining a mating direction Z-Z, and a fool-proof portion 12 spanning the mating slot 11.

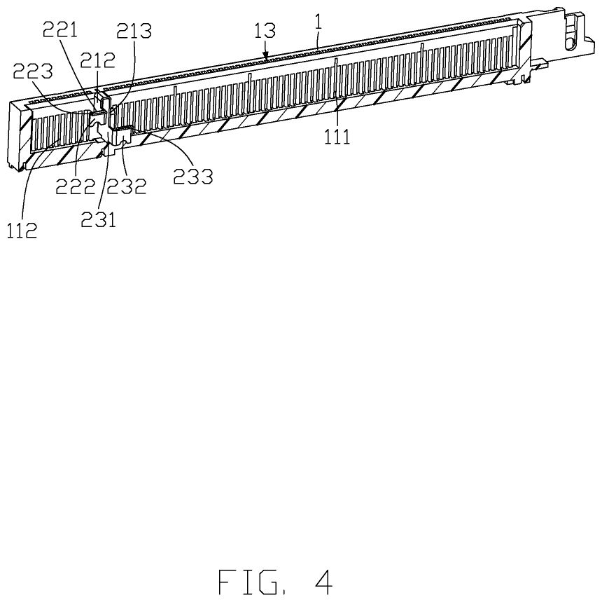

Referring to FIGS. 1-4, the fool-proof portion 12 divides the mating slot 11 into a first slot 111 and a second slot 112 in the first direction X-X, i.e., the longitudinal direction. The plurality of terminals 110 are disposed on the two side walls 101 respectively and located at two lateral sides of the mating slot 11 in a second direction Y-Y perpendicular to the first direction X-X, i.e., the lateral direction. Referring to FIGS. 4-6, the reinforcing member has a bent body 21, and a first extension portion 22 and a second extension portion 23 connected to the bent body 21. The bent body 21 includes a first body 212 covering a top surface of the fool-proof portion 12, and a second body 211 and a third body bent 213 downward from opposite ends of the first body 212 respectively. The second body 211 and the third body 213 cover opposite sides of the fool-proof portion 12 respectively and face the second slot 112 and the first slot 111 respectively. The first extension portion 22 has a first extension body 221 extending laterally from the second body 211 and two first bent portions 222 bent from two lateral edges of the first extension body 221 respectively. The first bent portions 222 are fixed to the corresponding side wall 101. The second extension portion 23 has a second extension body 231 extending laterally from the third body 213 and two second bent portions 232 bent from two lateral edges of the second extension body 231 respectively. The second bent portions 232 are fixed to the corresponding side wall 101.

As shown in FIGS. 4 to 6, The fool-proof portion 12 can restrict the displacement of the electronic card and improve the installation accuracy of the electronic card. The reinforcing member 2 forms a partial covering structure on the fool-proof portion 12 and occupies almost no space of the mating slot 11 in the first direction. The bent body 21, the first extension body 221, and the second extension body 231 cover at least part of the surface of the fool-proof portion 12, which can effectively enhance the strength of the fool-proof portion 12, reduce friction between the electronic card and the fool-proof portion 12 during insertion, and thereby improve the wear resistance and impact strength of the electrical connector 10. The second body 211, first body 212, and third body 213 respectively fit and cover the top surface and two side surfaces of the fool-proof portion 12, enabling the reinforcing member 2 to better resist impact forces and distribute the impact forces to the insulating housing 1, thereby improving the impact resistance of the electrical connector 10 in the first direction X-X and the mating direction Z-Z.

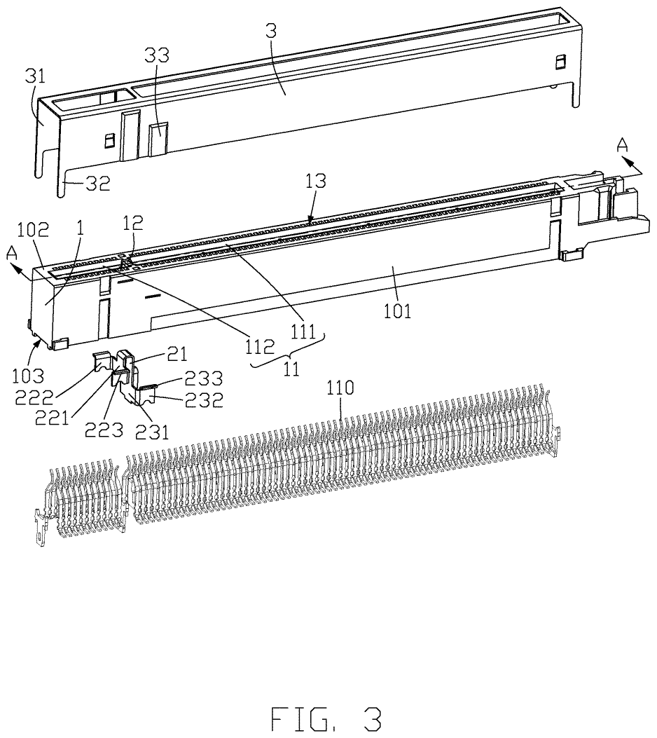

As shown in FIG. 3, the insulating housing 1 includes a top wall 102 and a bottom wall 103. The mating slot 11 is recessed from the top wall 102 toward the bottom wall 103 and is used for the insertion of electronic cards such as graphics cards.

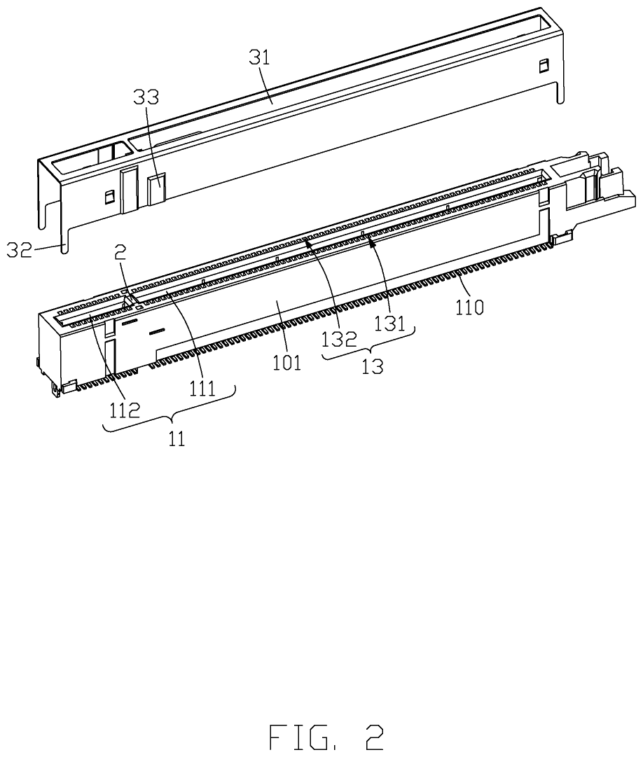

Referring to FIGS. 1-3, the insulating housing 1 includes two rows of terminal mounting holes 13 for mounting the terminals 110. The two rows of terminal mounting holes 13 are located on both sides of the mating slot 11 along the first direction X-X respectively. Each end of the terminal mounting holes 13 penetrates through the top wall 102 and the bottom wall 103 along the mating direction Z-Z. Referring to FIG. 2, the two rows of terminal mounting holes 13 include a row of first terminal holes 131 and a row of second terminal holes 132, both of which communicate with the mating slot 11. The first terminal holes 131 and the second terminal holes 132 are used for mounting the terminals 110, so that after the electronic card is mated with the mating slot 11, the portions of the terminals 110 extending into the mating slot 11 from the first terminal holes 131 and the second terminal holes 132 can be connected to the electronic card, thereby achieving reliable electrical connection and stable signal transmission between the electronic card and the electrical connector 10.

Referring to FIG. 3, the fool-proof portion 12 is a plate-like structure within the mating slot 11 and formed integrally with the insulating housing 1. The fool-proof portion 12 can reduce errors such as incorrect insertion direction, poor contact, or damage to the electrical connector 10 during the mating process. It can also restrict the displacement of the electronic card, ensuring stable installation of the card.

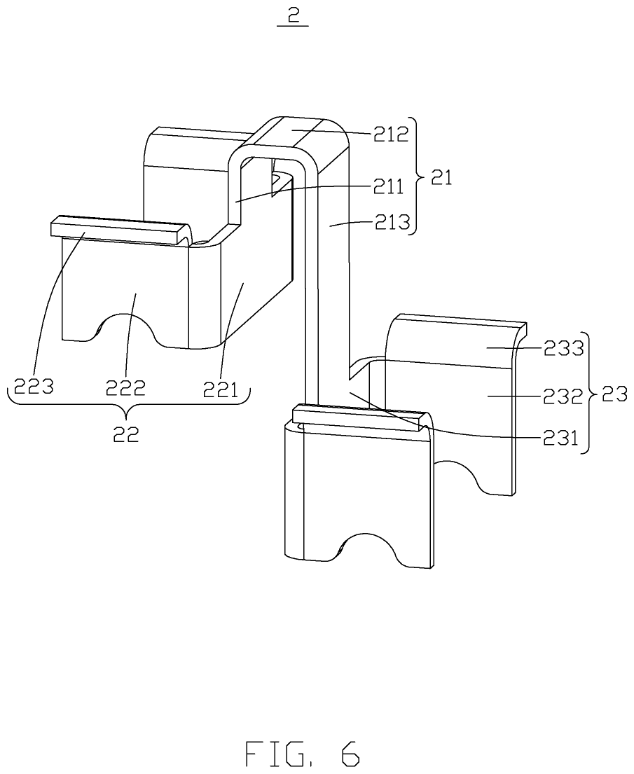

Referring to FIG. 6, the reinforcing member 2 is fixed to the fool-proof portion 12 along the mating direction Z-Z to enhance the strength of the fool-proof portion 12. Specifically, the bent body 21 matches the shape of the fool-proof portion 12 and is approximately U-shaped. The first extension portion 22 and the second extension portion 23 are respectively extending from the two ends of the bent body 21, and are plate-like structures parallel to the plane defined by the mating direction Z-Z and the second direction Y-Y. Along the second direction, the widths of the first extension portion 22 and the second extension portion 23 are greater than the width of the bent body 21. The reinforcing member 2 can cover the top surface and two side surfaces of the fool-proof portion 12, which can effectively enhance the strength of the fool-proof portion 12 and reduce friction between the electronic card and the fool-proof portion 12 during insertion. In addition, it can effectively distribute the impact force along the first direction into the insulating housing 1, thereby improving the wear resistance and impact strength of the electrical connector 10. At the same time, the reinforcing member 2 covering the fool-proof portion 12 does not reduce the available insertion length of the mating slot 11, thus facilitating the installation of the card.

The first extension body 221 and the second extension body 231 cover the two side surfaces of the fool-proof portion 12 along the first direction X-X. The first extension body 221 and the second extension body 231 extend into the side walls 101 along the second direction Y-Y. The first bent portions 222 and the second bent portions 232 are both plate-like structures and are parallel to the side walls 101. The first bent portions 222 and the second bent portions 232 are located inside the side walls 101. In a preferred embodiment, the first bent portions 222 and second bent portions 232 are insert-molded in the corresponding side wall 101. The arrangement of the first extension body 221 and the second extension body 231 can enhance the mounting strength of the reinforcing member 2 on the fool-proof portion 12 and further improve the impact resistance of the fool-proof portion 12 along the first direction X-X. In other words, the first extension portion 22 and the second extension portion 23 not only cover the surface of the fool-proof portion 12 but also improve the mounting stability of the reinforcing member 2. Moreover, when the reinforcing member 2 is subjected to an impact force in the second direction, the first bent portions 222 and the second bent portions 232 can better distribute the impact force to the insulating housing 1.

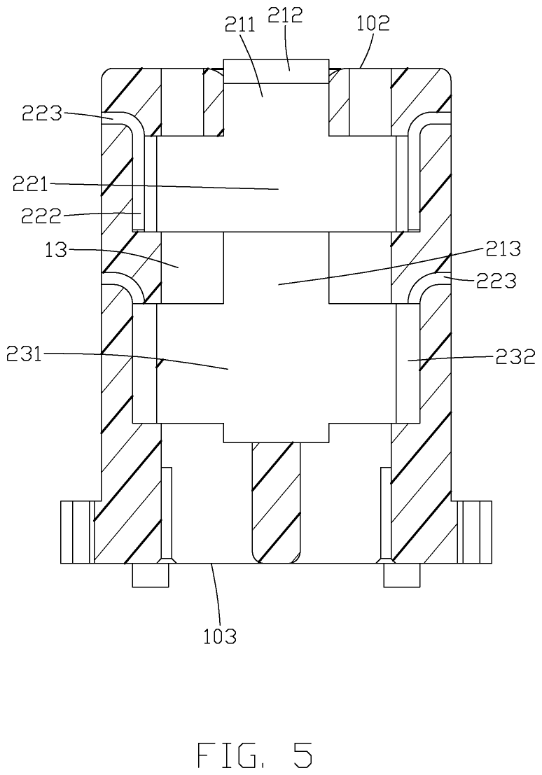

Referring to FIG. 5, the first extension portion 22 includes a first terminal strip portion 223 bent from the first bent portion 222 and extending out of the side wall 101. The second extension portion 23 includes a second terminal strip portion 233 bent from the second bent portion 232 and extending out of the side wall 101. The first terminal strip portion 223 and the second terminal strip portion 233 are disposed within the side wall, which can enhance the retention force between the reinforcing member 2 and the side wall, thereby further improving the mounting stability of the reinforcing member 2. In addition, the first terminal strip portion 223 and the second terminal strip portion 233 can distribute impact forces in the mating direction to the insulating housing 1, thereby improving the impact resistance of the electrical connector 10 in the mating direction.

Referring to FIG. 6, the second body 211 and the third body 213 have different lengths in the mating direction. This configuration reduces the material usage of the reinforcing member 2 while still allowing the second body 211 and the third body 213 to enhance the strength of the two surfaces of the fool-proof portion along the first direction. A distance between the first extension portion 22 and the top wall 102 is less than a distance between the second extension portion 23 and the top wall 102. The first extension portion 22 and the second extension portion 23 are embedded in the side wall 101, with the reinforcing member 2 being fixed to an upper portion and a lower portion of the insulating housing 1, thereby enhancing the mounting stability of the reinforcing member 2.

The first extension portion 22 and the second extension portion 23 offset from each other seen in the first direction, allowing the first extension portion 22 and the second extension portion 23 to better distribute impact forces along the first direction.

Referring to FIGS. 2-3, the electrical connector 10 has a metal shell 3 covering the insulating housing 1 and being a rectangular shell. The metal shell 3 has two opposite side plates, a receiving cavity 31, and two openings corresponding to a top and bottom of the metal shell 3. When the metal shell 3 is assembled with the insulating housing 1, at least a portion of the insulating housing 1 enter the receiving cavity 31 through the bottom opening of the metal shell 3. The top opening is corresponding to the mating slot 11 and using for ducking the electronic card. The metal shell 3 can resist external forces such as vibration, impact, or compression, and can reduce the influence of such external forces on the insulating housing 1 and the terminals 110.

the metal shell 3 has two pairs of supporting members 32, which are disposed on a bottom surface of the metal shell 3 along the mating direction Z-Z and located at both ends of the metal shell 3. The supporting members 32 extend from the two opposite side plates of the metal shell 3 along the mating direction. Each side plates has supporting members 32 at both ends along the first direction X-X. The electrical connector 10 can be supported and fixed to a PCB by the supporting members 32, ensuring precise mating between the electrical connector 10 and the PCB. In addition, since the supporting members 32 are made of metal and have high rigidity, they can provide buffering and support for the electrical connector 10 during operation, absorb vibrations generated during device operation, and ensure the mounting stability of the electrical connector 10 on the PCB.

Referring to FIGS. 1-2, the side faces of the metal shell has protrusions 33 protruding outwardly corresponding to the first terminal and the second terminal strip portion 233. The protrusions 33 ensure that the metal shell 3 and the insulating housing 1 can be properly assembled.

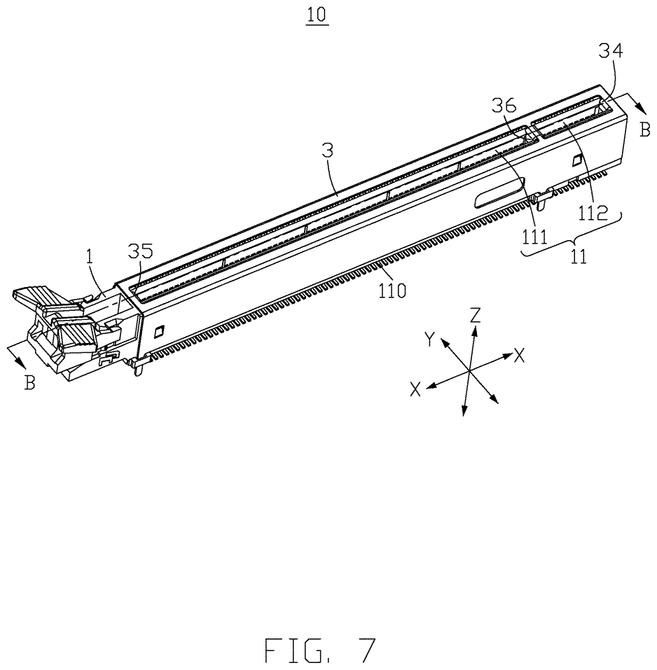

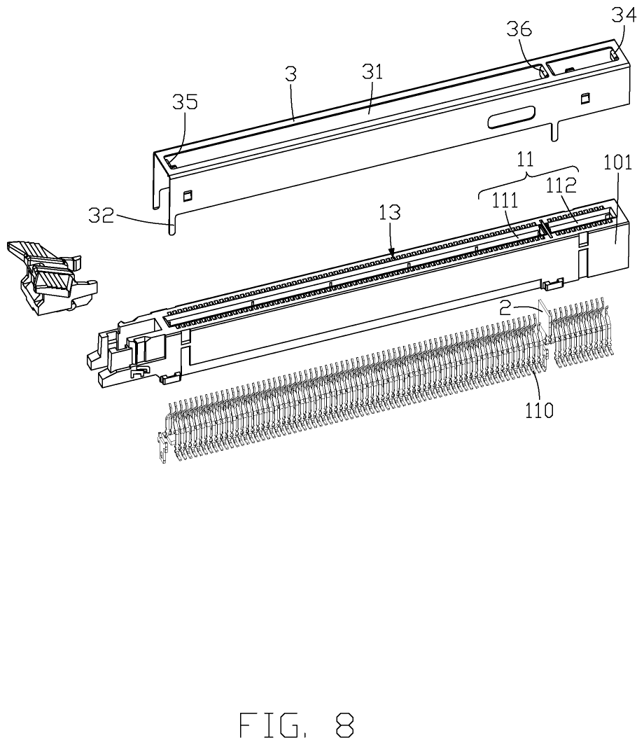

FIGS. 7-10 illustrate a second embodiment of the present invention. Unlike the first embodiment, in the second embodiment, a reinforcing member includes a fifth extension portion 36 extending from the metal shell 3 and a metallic reinforcing plate 2 embedded within the fool-proof portion 12. The metal shell 3 has two opposite side plates. The fifth extension portion 36 has a fifth body 362 connecting with the two side plates of the metal shell 3 and covering a top surface of the fool-proof portion 12, and a fourth body 361 and a sixth body 363 bent downward from two ends of the fifth body 362 respectively, the fourth body 361 and the sixth body 363 cover two sides of the fool-proof portion 12 respectively and face the second slot 112 and the first slot 111 respectively. The fifth body 362 is disposed across the top opening of the metal shell 3. The fourth body 361 and the sixth body 363 extend downward to the mating slot 11.

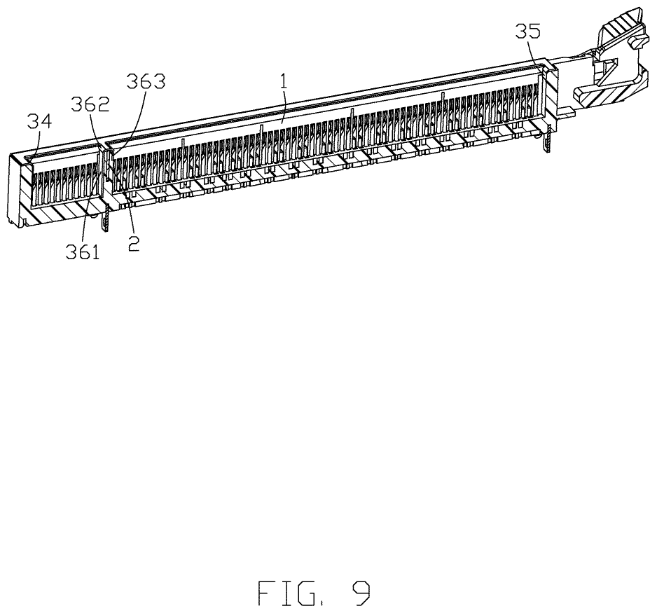

Referring to FIG. 9, the reinforcing plate 2 is insert-molded or assembled within the fool-proof portion 12, which can enhance the overall strength and the surface strength of the fool-proof portion 12 and will not affect the appearance and dimensions of the insulating housing 1. When the fool-proof portion 12 is subjected to an impact, the force can be distributed to the insulating housing 1. The reinforcing plate 2 is a stainless steel plate with a thickness of 0.4 mm.

Specifically, the metal shell 3 has extension structures, so that when the metal shell 3 is mounted onto the insulating housing 1, the extension structures cover both ends of the fool-proof portion 12 and the insulating housing 1 along the first direction, thereby enhancing the wear resistance and impact strength of the electrical connector 10.

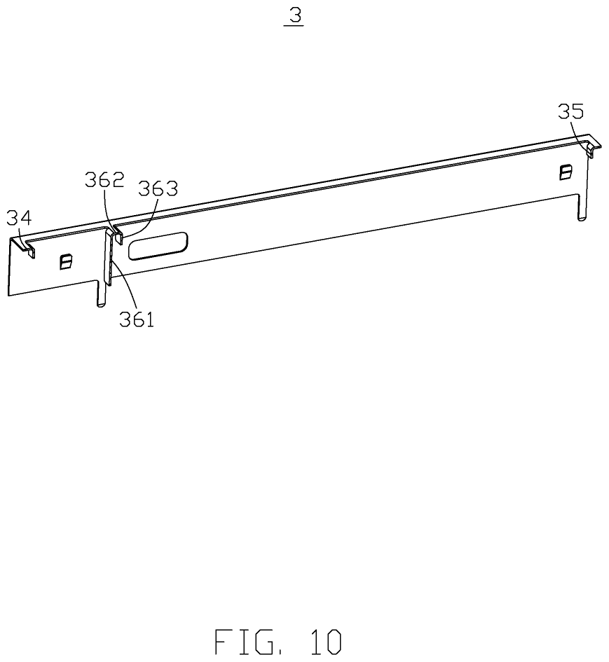

Referring to FIG. 10, two ends of the metal shell 3 has a third extension portion 34 and a fourth extension portion 35 respectively. The metal shell 3 has the fifth extension portion 36 corresponding to the fool-proof portion 12. The third extension portion 34 and the fourth extension portion 35 are approximately L-shaped structures, while the fifth extension portion 36 is approximately U-shaped.

When the insulating housing 1 is received in the receiving cavity 31 of the metal shell 3, the third extension portion 34 covers at least part of an end surface of the second slot 112 that is away from the first slot 111, and the fourth extension portion 35 covers at least part of an end surface of the first slot 111 that is away from the second slot 112. The third extension portion 34, the fourth extension portion 35, and the fifth extension portion 36 can better distribute the impact force to the insulating housing 1.

The reinforcing member in the second embodiment includes the fifth extension portion 36 and the reinforcing plate 2, the metal proportion of the fool-proof portion can reach 50.56%.

The above-mentioned embodiments are only preferred embodiments of the present invention, and should not limit the scope of the present invention, any simple equivalent changes and modifications made according to the claims of the present invention and the contents of the description should still belong to the present invention.

1. An electrical connector comprising:
an insulating housing having two opposite side walls extending in a first direction, a mating slot located between the two side walls and defining a mating direction, and a fool-proof portion spanning the mating slot, the fool-proof portion dividing the mating slot into a first slot and a second slot in the first direction;
a plurality of terminals disposed on the two side walls respectively and located at two lateral sides of the mating slot; and
a reinforcing member retained on the insulating housing;
wherein the reinforcing member comprises:
a bent body comprising a first body covering a top surface of the fool-proof portion, and a second body and a third body bent downward from opposite ends of the first body respectively, the second body and the third body covering opposite sides of the fool-proof portion respectively and facing the second slot and the first slot respectively;
a first extension portion comprising a first extension body extending from the second body and two first bent portions bent from two lateral edges of the first extension body respectively, the first bent portions being fixed to corresponding side walls; and
a second extension portion comprises a second extension body laterally from the third body and two second bent portions bent from two lateral edges of the second extension body respectively, the second bent portions being fixed to corresponding side walls.

2. The electrical connector as claimed in claim 1, wherein the second body and the third body have different lengths in the mating direction.

3. The electrical connector as claimed in claim 1, wherein a distance between the first extension portion and a top surface of the insulating housing is less than a distance between the second extension portion and the top surface of the insulating housing.

4. The electrical connector as claimed in claim 1, wherein the first extension portion and the second extension portion offset from each other as viewed in the first direction.

5. The electrical connector as claimed in claim 1, wherein the first bent portion and the second bent portion are parallel to the side wall.

6. The electrical connector as claimed in claim 1, wherein the first extension portion has a first terminal strip portion bent from the first bent portion and extending out of the side wall, and the second extension portion has a second terminal strip portion bent from the second bent portion and extending out of the side wall.

7. The electrical connector as claimed in claim 6, further comprising a metal shell covering the insulating housing and shielding the first terminal strip portion and the second terminal strip portion.

8. The electrical connector as claimed in claim 7, wherein the metal shell comprises supporting members disposed on a bottom surface thereof and located at both ends thereof.

9. The electrical connector as claimed in claim 7, wherein the metal shell has protrusions protruding outwardly corresponding to the first terminal strip portion and the second terminal strip portion.

10. The electrical connector as claimed in claim 1, wherein the first extension body and the second extension body cover two side surfaces of the fool-proof portion respectively and extend into the side walls in a second direction perpendicular to the side walls.

11. The electrical connector as claimed in claim 1, wherein the first bent portions and the second bent portions are insert-molded in corresponding side walls.

12. An electrical connector comprising:
an insulating housing having two opposite side walls extending in a first direction, a mating slot penetrating upward between the two side walls, and a fool-proof portion connecting the two side walls in a second direction perpendicular to the first direction, the fool-proof portion dividing the mating slot into a first slot and a second slot in the first direction;
two rows of terminals disposed on opposite sides of the mating slot respectively and fixed to corresponding side walls; and
a reinforcing member comprising a first body covering a top surface of the fool-proof portion and a second body and a third body bent downward from the first body; wherein
the second body and the third body cover opposite sides of the fool-proof portion respectively and face the second slot and the first slot respectively; and
the reinforcing member comprises a reinforcing plate embedded in the fool-proof portion or a first extension portion extending from the second body and embedded partly in the side wall.

13. The electrical connector as claimed in claim 12, wherein the reinforcing member has the reinforcing plate insert-molded or assembled in the fool-proof portion.

14. The electrical connector as claimed in claim 13, further comprising a metal shell covering the insulating housing, wherein the metal shell has two opposite side plates, and the first body connects with the two side plates.

15. The electrical connector as claimed in claim 14, wherein the metal shell has an opening corresponding to the mating slot, the first body is disposed across the opening, and the second body and the third body extend downward to the mating slot.

16. The electrical connector as claimed in claim 12, wherein the reinforcing member comprises the first extension portion having a first extension body extending from the second body and two first bent portions bent from two lateral edges of the first extension body respectively, and the first bent portions are fixed to corresponding side walls.

17. The electrical connector as claimed in claim 16, wherein the reinforcing member comprises a second extension portion having a second extension body extending laterally from the third body and two second bent portions bent from two lateral edges of the second extension body respectively, and the second bent portions are fixed to corresponding side walls.

18. The electrical connector as claimed in claim 17, wherein the first bent portions and second bent portions are insert-molded in corresponding side walls.

19. The electrical connector as claimed in claim 17, wherein the first extension portion and the second extension portion has no overlap portion as viewed in the first direction.

20. The electrical connector as claimed in claim 12, wherein the second body and the third body have different lengths in a mating direction orthogonal to the first direction and the second direction.
